(19) United States
(12) Patent Application Publication
(10) Pub. No.: US 2006/0099354 A1
(43) Pub. Date: May 11, 2006

(54) Plastic vehicle parts with integrated antenna elements and method for the production thereof

(75) Inventors: Walter Aichholzer, Hemmingen (DE); Andreas Fleckenstein, Aschaffenburg (DE); Pascal Hofmann, Ulm (DE); Holger Rothenburger, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Daimler Chrysler AG, Stuttgart (DE)

(21) Appl. No.: 10/527,073

(22) PCT Filed: Sep. 8, 2003
(86) PCT No.: PCT/DE03/02984

§ 371 Date: Jan. 6, 2006

(30) Foreign Application Priority Data
Sep. 12, 2002 (DE) 102 42 526.4

(51) Int. Cl. B32B 15/04; B32B 9/04

(52) U.S. Cl. 428/31; 427/256; 428/411.1; 428/457

(57) ABSTRACT

A method for producing a vehicle part with an integrated antenna element includes providing a plastic substrate by a molding process, providing a coating layer by a film coating process, and providing at least one antenna element disposed between the coating layer and the plastic substrate.

The invention relates to a method for producing vehicle parts from plastic in which antenna elements are integrated, and also to the components produced by this method.

The use of plastic components as a substitute for conventional metal parts has become much more popular in recent years, in particular in automobile construction. From aspects of lightweight construction in particular, plastic components represent an interesting alternative to metal parts. In addition, they can be produced at low cost, for example by the use of injection-molding processes.

To protect these parts and to improve their visual appearance, it is desirable to coat the surface of the components.

A coating method that is particularly suitable for plastic components is specified for example in U.S. Pat. No. 5,156,882. This involves applying a system of layers comprising three layers which have UV-absorbing and scratch-resistant properties to a plastic substrate.

The use of said plastic components in automobile construction creates further requirements, but also additional potential for these components. For example, their transparency to electromagnetic waves makes them virtually ideal as supports for the mounting of antennas, for example for radio transmission systems or radar systems. Central points here are the optimum utilization of the existing confined installation space and also minimal impairment of the visual appearance of the vehicle by the antenna systems. This problem is countered by existing systems in various ways.

For example, WO 92/21161 proposes an antenna assembly which is formed as a two-dimensional element and is applied to plastic components of a vehicle body. Here, the antenna structure is separately produced and applied to or integrated in the body part in an additional processing step. A disadvantage of this method is that the application of the antenna structure as an additional operation entails increased expenditure for the adjustment of the structure; furthermore, when the antenna structure is arranged on the surface of the component, protection against mechanical stresses is not optimal.

The invention is based on the object of integrating antenna elements in plastic components in a simple and low-cost manner and also of ensuring maximum mechanical protection of said antenna elements.

This object is achieved by the method with the features described in Claim 1 and by the devices with the features stated in Claims 11 and 19. The features described in the subclaims form advantageous further developments of the invention.

According to the invention, the antenna elements are introduced into the plastic structures as part of a coating method for plastic parts. This involves arranging the two-dimensionally formed antenna elements between the coating layer and the component to be coated, the so-called plastic substrate. As a difference from WO 92/21161, a departure is made here from the monolithic view of the plastic part as a structural unit and the coating layer and plastic substrate are considered as individual components of the plastic part; the space between these two components is advantageously utilized according to the invention.

Dipole antennas, loop antennas and the slot antennas that are particularly suitable for mobile radio are conceivable for example as antenna elements, with the necessary electrical/electronic components such as couplers, filters and distribution networks, for example.

By applying the antenna elements between the coating layer and the plastic substrate, a series of advantages are realized. By arranging the antenna element on the surface of the plastic substrate, the positioning of the element is made much easier by using the surface of the plastic as a reference surface; at the same time, the coating layer covering the antenna element offers optimum protection against external influences, consequently offers a radome function and, as a superstrate, influences the electrical properties of the antenna. Furthermore, this method allows the integration of the surface finish and the antenna mounting in one operation. In addition, the space requirement of the antenna element is reduced by the integration in the space between the coating layer and the plastic substrate. Since the antenna elements can be produced from thin conducting films, for example, there is no longer any impairment of the visual appearance of the vehicle; it is consequently no longer necessary to take account of the integration of the antennas in design considerations. The application of the antenna structure can be integrated easily in existing production processes and consequently causes only very low extra financial expenditure.

Recently, film coating methods have proven to be particularly successful for the coating of the plastic parts. These methods make it possible to dispense with laborious wet coating; they are consequently superior to the traditional methods from an economic viewpoint.

A method of this type is proposed in EP 0 819 520 A2. In the method described, a pre-cured coating film substantially comprising a coloured layer and a clear-coat layer and also a substrate film is applied to the component to be coated and is finally cured by electromagnetic radiation.

A further development of the aforementioned method is described in EP 0 819 516 A2. Here, the coating film is applied to the component to be coated during a molding process. The molding process may be, for example, an injection-molding, injection/compression-molding or foam-backing process. In the case of injection-molding, liquid polymer is injected into a closed injection mold. In this case, the substrate material is made to begin melting by the hot polymer and the film enters into a covalent bond with the backing material.

When the antenna elements are integrated in the plastic components, it has proven to be particularly successful to integrate the introduction of the elements together with the coating operation in the molding process. For example, it is advantageous when using a mold to introduce the antenna elements into the mold before the molding operation. After the molding process, the surface of the components with the already superficially integrated antenna elements can then be treated either by a conventional coating method or by a film coating method.

When a film coating method is used, it is similarly possible to apply the antenna elements to the coating film before the molding process. After that, the coating film is introduced into the mold and subsequently has a backing substrate applied to it by an injection-molding or foaming process. In this way, the introduction of the antenna elements is integrated into the coating and molding operation in a particularly advantageous way.

It goes without saying that the processes that have proven successful for the metallization of films, such as structured direct metallization or screen-printing processes for example, can be used in an advantageous way for applying the antenna elements to the coating film. In the case of direct metallization, the coating film is initially chemically activated; subsequently, a thin layer of metal is deposited on the rear side of the coating film in a metallic salt solution and is subsequently galvanically reinforced to the thickness necessary for adequate mechanical stability and electrical conductivity. Following that, the metal layer can be structured by known photolithographic processes. The main advantages of this process are the high achievable accuracy and the good adhesion of the metal layer on the coating film.

It goes without saying that the plastic substrates can also be metallized by the processes mentioned.

For an alternative preparation of the antenna elements, various methods may be used in an advantageous way. For example, it is favourable to punch the antenna elements out from a metal foil as punched parts and adhesively attach them to the coating film or the plastic substrate as a preparatory step. This makes it possible to dispense with the use of chemicals entirely; the achievable accuracies meet the requirements for use as an antenna element without any problem. Commercially available copper adhesive tape with a total thickness of 65 μm (35 μm copper and 30 μm acrylate adhesive) has proven to be particularly successful for this.

Similarly, conductor structures arranged on substrates, such as foil conductors or prepared printed circuit boards for example, offer good possibilities for applying the antenna structures to the coating film or the plastic substrate.

For the integration of antenna elements by the aforementioned method, it is also advantageous to realize the antenna elements as insert parts in the form of pre-structured single-layer or multi-layer substrates with so-called “stacked patches”.

For optimum coating of components, it has proven successful to preform the coating film by means of a thermoforming process before the injection-molding or foam-backing process. This ensures a smooth, blister-free coating surface. Given appropriate flexibility and robustness, the antenna elements can be applied here to the coating film before the thermoforming process; alternatively, application to the coating film after the thermoforming process is also conceivable. A further advantageous variant of the production of the plastic components is to use the geometry of the mold that is used in an advantageous way for the positioning of the antenna elements, for example by means of a robot. Alternatively, automatic alignment of the antenna elements may be performed by means of optical methods, such as image recognition methods for example.

There are various possibilities for the contacting of the antenna elements in the component. For example, the antenna element may be directly galvanically contacted. For this purpose, it is necessary for a waveguide to be led through the plastic to the cast-in antenna element. It is appropriate to provide the component with a drilled hole after the molding process, reaching through as far as the introduced antenna element, and subsequently to contact the antenna element directly, for example by means of the inner conductor of a coaxial panel jack.

It is particularly advantageous to provide the leading-through of the conductor already during the molding process. For example, the opening necessary for this can already be taken into account in the design of the mold and in this way dispense with a subsequent further working step, such as drilling for example.

Similarly, it is of advantage already to provide during the molding process a suitable insert part by means of which the antenna element is contacted through the surrounding plastic.

A further possibility for coupling the antenna element is so-called aperture coupling. This dispenses with the direct galvanic contacting of the antenna element; rather, a module which contains a feed network with a feed line and the electrical and electronic components necessary for the coupling to the antenna element is attached to the rear side of the plastic component. This procedure makes the otherwise necessary throughplating through the plastic superfluous, with the result that the production process is further simplified.

The module with the feed network is separated from the antenna element by a ground plane. In this case, the energy transmission takes place through a gap in the ground plane by means of the magnetic coupling of the feed line with the antenna element. The coupling is maximized here if the gap is placed under the centre of the antenna element. As a difference from direct contacting, aperture coupling has a large number of variable parameters. For example, the input resistance is influenced by the geometrical properties of the gap and its position under the antenna element.

A further advantage of aperture coupling is its higher bandwidth in comparison with direct contacting.

For it to operate optimally, the module is structured on two sides: the side facing the antenna receives the ground plane for the antenna and the feed line with the associated coupling gaps; the ground plane thereby additionally shields against the parasitic radiation emitted by the feed network and in this way ensures the high polarization purity of the arrangement. The side facing away from the antenna contains the feed network. In addition, further active and passive circuits, such as antenna amplifiers, filters, etc., may be integrated on this side in an advantageous way. It goes without saying that this embodiment of the module is also suitable in the case of direct contacting of the antenna element.

A particularly advantageous embodiment of the module consists in providing that it is integrated in a housing which can be attached in a defined manner to the plastic part, for example by a latching or adhesive-bonding technique. In this way, the spatial alignment of the coupling slots with respect to the introduced antenna element is defined in an advantageous way and the attachment of the module is simplified. In addition, easy exchangability of the module is ensured, for example in the case of hardware updates.

In the case where the antenna is formed as a microstrip antenna, an additional ground plane is required, forming a resonator with the antenna element integrated in the plastic part in the form of a patch. This ground plane may be applied to the rear side of the component by the molding process. This arrangement is particularly well-suited for two-dimensionally formed components and displays particularly positive properties for the reception of GPS signals.

It has proven successful here to make the ground plane take the form of a metal adhesive film, direct metallization or screen print.

The invention is explained below on the basis of two exemplary embodiments and the associated drawings, in which:

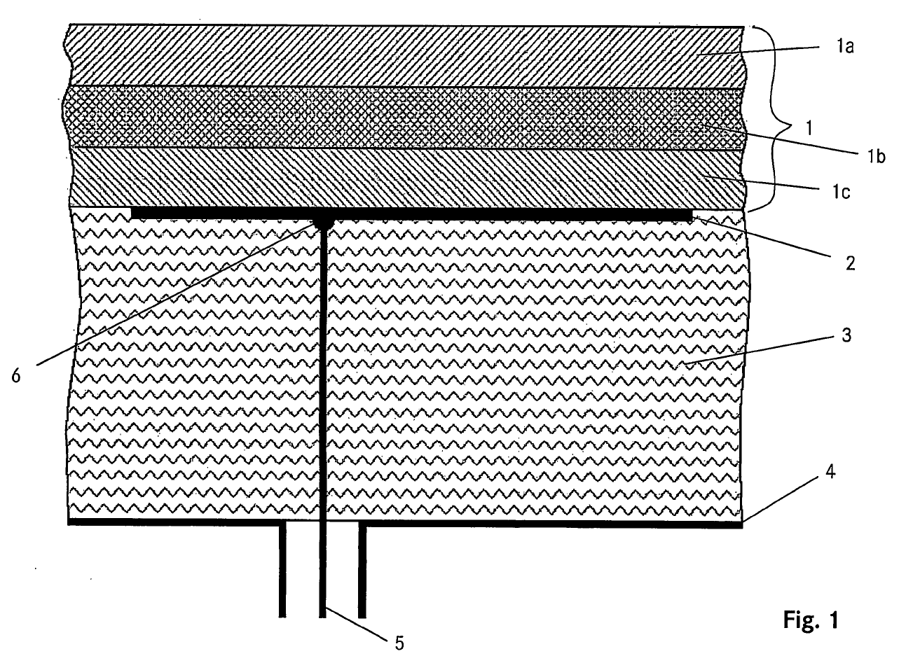

FIG. 1 shows a section through a component according to the invention with a directly contacted antenna element.

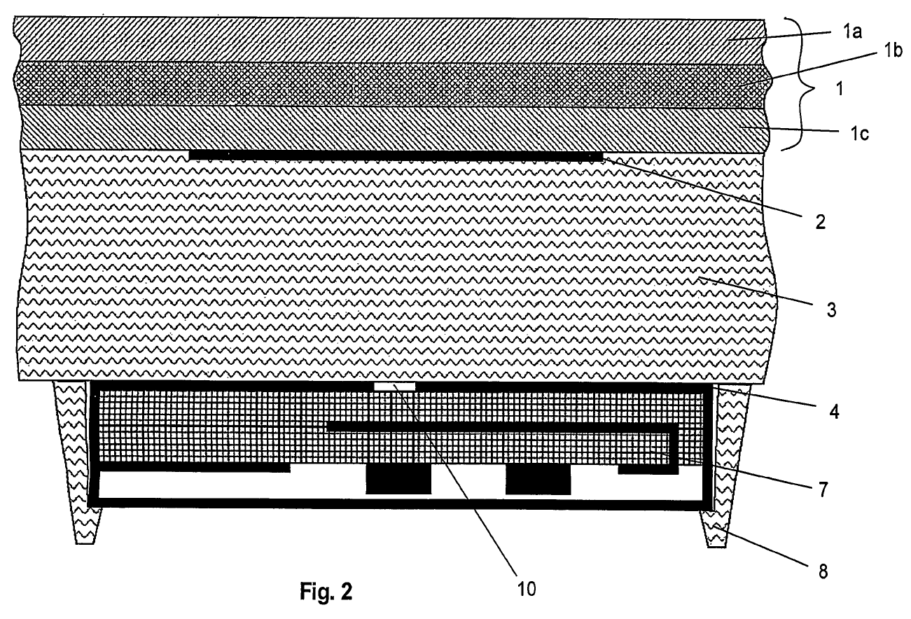

FIG. 2 shows a section through a component according to the invention with aperture coupling.

FIG. 1 shows a directly contacted antenna element in the component. The antenna element is arranged here between the coating film 1 and the backing material 3. The coating film comprises a clear-coat layer 1a, a coloured layer 1b and the substrate layer 1c. Arranged between the substrate layer 1c and the backing material 3 is the antenna element in the form of a patch 2. To simplify the contacting, the antenna element is provided with a soldering point 6 before the injection molding of the backing material. After the injection molding of the backing material, this soldering point is drilled to through the backing material 3, and the inner conductor 5 of a coaxial line is led through the drilled hole to the antenna element 2. The rear termination of the antenna structure is formed by the ground plane 4, which is applied to the backing material 3. Simple locating of the antenna element 2 integrated in the component is made much easier by the choice of a transparent backing material 3.

FIG. 2 shows a component with an integrated antenna element 2, in which the energy transmission to the antenna element takes place by means of an aperture coupling. In the case of this structure, too, the antenna element 2 is arranged in the way described above between the coating film 1 and the backing material 3. As a difference from direct contacting, in the arrangement presented here no leading-through of conductors through the backing material 3 is required. Rather, in the embodiment described here, the ground plane 4 is formed as part of a module 7 attached to the rear of the component. In this case, the ground plane 4 has a gap 10, through which the magnetic coupling of the antenna element 2 takes place. Here, the electrical and electronic components necessary for activating the antenna element 2 are integrated in the module 7. For the mechanical fixing and correct positioning, in particular of the coupling gap with respect to the antenna element, latching and retaining elements 8 are attached, it being possible in an advantageous way for these to be provided already during the molding process by the design of the mold.

1-19. (canceled)

20. A method for producing a vehicle part with an integrated antenna element, the method comprising:
providing a plastic substrate by a molding process;
providing a coating layer by a film coating process; and
providing at least one antenna element disposed between the coating layer and the plastic substrate.

21. The method as recited in claim 20 wherein the providing the at least one antenna element is performed during the molding process.

22. The method as recited in claim 20 wherein the providing the at least one antenna element is performed by applying the at least one antenna element to at least one of the coating film and the plastic substrate by at least one of a structured direct metallization and a screen-printing process.

23. The method as recited in claim 20 wherein the providing the at least one antenna element includes applying at least one of a punched part of metal adhesive film and an arrangement of lines on a second substrate to at least one of the coating film and the plastic substrate.

24. The method as recited in claim 20 further comprising preforming the coating layer by a thermoforming process.

25. The method as recited in claim 21 wherein the providing the at least one antenna element is performed by positioning the at least one antenna element using a mold of the molding process as a reference therefore.

26. The method as recited in claim 20 further comprising drilling a hole in the plastic substrate after the molding process, the hole being configured to receive an electrical connection.

27. The method as recited in claim 20 wherein the providing the plastic substrate is performed so as to provide, by a suitable design of the mold of the molding process, an opening through which the antenna element is capable of being contacted.

28. The method as recited in claim 21 further comprising introducing a conductive insert part during the molding process, the at least one antenna element being contactable via the conductive insert part.

29. A vehicle part comprising:
a plastic substrate;
a coating layer including a film coating layer bonded to the plastic substrate; and
at least one antenna element disposed between the plastic substrate and the coating layer.

30. The vehicle part as recited in claim 29 further comprising a contacting device configured to directly contact the at least one antenna element.

31. The vehicle part as recited in claim 29 further comprising a coupling device configured to electromagnetically couple the at least one antenna element.

32. The vehicle part as recited in claim 31 wherein the coupling device includes an aperture coupling.

33. The vehicle part as recited in claim 29 further comprising an electronic component module coupled to the at least one antenna element, the module including at least one of an active and a passive electronic component.

34. The vehicle part as recited in claim 33 wherein the at least one of an active and a passive electronic component includes at least one of a filter and an antenna amplifier.

35. The vehicle part as recited in claim 33 further comprising at least one positioning element configured to position the module on the vehicle part in a positionally accurate manner with respect to the at least one antenna element.

36. The vehicle part as recited in claim 29 further comprising a ground plane.

37. The vehicle part as recited in claim 36 wherein the ground plane includes at least one of a metal adhesive film, a direct metallization and a screen print.

38. A vehicle comprising a plastic part, the plastic part comprising:
a plastic substrate;
a coating layer including a film coating layer bonded to the plastic substrate; and
at least one antenna element disposed between the plastic substrate and the coating layer.
